(19) United States
(12) Patent Application Publication
(10) Pub. No.: US 2026/0038863 A1
(43) Pub. Date: Feb. 5, 2026

(54) Electrode Supply Apparatus and Electrode Assembly Manufacturing Apparatus Using Same, and Electrode Supply Method and Electrode Assembly Manufacturing Method Using Same

(71) Applicant: LG Energy Solution, Ltd., Seoul (KR)

(72) Inventor: Jong Seok Kim, Daejeon (KR)

(73) Assignee: LG Energy Solution, Ltd., Seoul (KR)

(21) Appl. No.: 18/997,433

(22) PCT Filed: Dec. 22, 2023
(86) PCT No.: PCT/KR2023/021393

§ 371 Date: Jan. 21, 2025

(30) Foreign Application Priority Data
Dec. 26, 2022 (KR) 10-2022-0184446

(51) Int. Cl. H01M 10/04; B65H 3/08; B65H 3/16; B65H 7/00

(52) U.S. Cl. CPC H01M 10/0404; B65H 3/0816; B65H 3/16; B65H 7/00; H01M 10/0468; B65H 2301/4234

(57) ABSTRACT

An electrode supply device, an electrode assembly manufacturing apparatus using the electrode supply device, an electrode supply method, and an electrode assembly manufacturing method using the electrode supply method are described. The electrode supply device includes: an electrode magazine unit in which a plurality of electrodes is stacked; an electrode pickup unit configured to pick up a first electrode among the plurality of electrodes; and an electromagnetic inductor configured to be able to induce an electric field or a magnetic field. One of the plurality of electrodes is separated from the first electrode by an electric field or magnetic field induced by the electromagnetic inductor.

### CROSS-REFERENCE TO RELATED APPLICATIONS

The present application is a national phase entry under 35 U.S.C. § 371 of International Application No. PCT/KR2023/021393, filed Dec. 22, 2023, published in Korean, which claims priority from Korean Patent Application No. 10-2022-0184446 filed Dec. 26, 2022, all of which are incorporated herein by reference.

### FIELD OF THE INVENTION

The present invention relates to an electrode supply device, an electrode assembly manufacturing apparatus using the electrode supply device, an electrode supply method, and an electrode assembly manufacturing method using the electrode supply method.

### BACKGROUND OF THE INVENTION

Secondary batteries can be recharged, unlike primary batteries, and may be formed to have a small size and a large capacity. Accordingly, a lot of research and development on the secondary batteries are currently in progress. As technology development and demand for mobile devices increase, the demand for secondary batteries as an energy source is sharply increasing.

Secondary batteries are classified into coin type batteries, cylindrical type batteries, prismatic type batteries, and pouch type batteries depending on a shape of a battery case. In a secondary battery, an electrode assembly mounted inside a battery case is a chargeable and dischargeable power generating device having a structure in which electrodes and a separator are stacked.

The electrode assembly may be approximately classified into a jelly-roll type electrode assembly in which a separator is interposed between a positive electrode and a negative electrode, each of which is provided in the form of a sheet coated with an active material, and then, the positive electrode, the separator, and the negative electrode are wound, a stack-type electrode assembly in which a plurality of positive and negative electrodes with a separator interposed therebetween are sequentially stacked, and a stack and folding-type electrode assembly in which stack-type unit cells are wound with a separation film having a long length.

The electrode assembly is mostly manufactured by receiving individual electrodes from a magazine in which a plurality of single sheet-type electrodes are stacked. There is a problem that defects occur in the manufactured electrode assembly because an electrode to be supplied among the plurality of single sheet-type electrodes stacked in the magazine is not properly separated during the manufacturing process.

Therefore, there is a need for technology to properly separate an electrode to be supplied among the plurality of electrodes stacked in the magazine.

### BRIEF SUMMARY OF THE INVENTION

The present invention is to provide an electrode supply device, an electrode assembly manufacturing apparatus using the electrode supply device, an electrode supply method, and an electrode assembly manufacturing method using the electrode supply method.

An exemplary embodiment of the present invention provides an electrode supply device including: an electrode magazine unit in which a plurality of electrodes are stacked; an electrode pickup unit configured to pick up a first electrode among the plurality of electrodes; and an electromagnetic inductor configured to be able to induce an electric field or a magnetic field, wherein one of the plurality of electrodes is separated from the first electrode by an electric field or magnetic field induced by the electromagnetic inductor.

An exemplary embodiment of the present invention provides an electrode assembly manufacturing apparatus for manufacturing an electrode assembly including a negative electrode, a positive electrode, and a separator arranged between the negative electrode and the positive electrode, the electrode assembly manufacturing apparatus including: a negative electrode supply unit configured to supply the negative electrode to a stack table side; a positive electrode supply unit configured to supply the positive electrode to the stack table side; a separator supply unit configured to supply the separator to the stack table side; the stack table on which a stack in which the negative electrode, the separator, and the positive electrode are stacked such that the negative electrode and the positive electrode are alternately arranged between folds of the separator is manufactured; and a press unit configured to heat and press the stack to adhere the negative electrode, the separator, and the positive electrode therebetween, thereby manufacturing an electrode assembly, wherein at least one of the negative electrode supply unit and the positive electrode supply unit includes the above-described electrode supply device.

An exemplary embodiment of the present invention provides an electrode supply method including: fixing a first electrode among a plurality of electrodes stacked inside an electrode magazine unit by an electrode pickup unit; inducing an electric field or magnetic field in one of the plurality of electrodes stacked inside the electrode magazine unit by an electromagnetic inductor; and picking up the first electrode by the electrode pickup unit.

An exemplary embodiment of the present invention provides an electrode assembly manufacturing method for manufacturing an electrode assembly including a negative electrode, a positive electrode, and a separator arranged between the negative electrode and the positive electrode, the electrode assembly manufacturing method including: supplying the negative electrode to a stack table side; supplying the positive electrode to the stack table side; supplying the separator to the stack table side; manufacturing a stack by stacking the negative electrode, the separator, and the positive electrode on the stack table such that the negative electrode and the positive electrode are alternately arranged between folds of the separator; and heating and pressing the stack to adhere the negative electrode, the separator, and the positive electrode therebetween, thereby manufacturing an electrode assembly, wherein at least one of the supplying the negative electrode to the stack table side and the supplying the positive electrode to the stack table side includes the above-described electrode supply method.

The electrode supply device and the electrode supply method according to the exemplary embodiments of the present invention can prevent a problem of separation of multiple electrodes caused by contact between an electrode surface and an electrode surface or contact between the electrode surface and the separator.

The electrode assembly manufacturing apparatus and the electrode assembly manufacturing method according to the exemplary embodiments of the present invention can prevent the problem of separation of multiple electrodes. Therefore, when the electrode assembly is manufactured by the electrode assembly manufacturing apparatus and the electrode assembly manufacturing method, productivity can be improved.

### BRIEF DESCRIPTION OF THE DRAWINGS

FIG. 1 is a view showing a process of separating an electrode in an electrode supply device and an electrode supply method according to an exemplary embodiment of the present invention.

FIG. 2 is a plan view illustratively showing an electrode assembly manufacturing apparatus according to an exemplary embodiment of the present invention.

FIG. 3 is a front view showing a concept of the electrode assembly manufacturing apparatus according to the exemplary embodiment of the present invention.

FIG. 4 is a cross-sectional view illustratively showing a general electrode assembly.

FIG. 5 is a conceptual view showing a pressing process in the electrode assembly manufacturing method or electrode assembly manufacturing apparatus according to the exemplary embodiment of the present invention.

FIG. 6 is a process flow diagram of a stack manufacturing process according to an exemplary embodiment.

FIG. 7 is a process flow diagram of a stack manufacturing process according to another exemplary embodiment.

### EXPLANATION OF REFERENCE NUMERALS AND SYMBOLS

1: electrode stack unit
2: uppermost electrode among stacked electrodes
3: electrode in contact with uppermost electrode among stacked
electrodes
4: plurality of other electrodes
7: electrode magazine unit
10: electrode assembly
11: negative electrode
12: positive electrode
14: separator
100: electrode assembly manufacturing apparatus
110: stack table
120: separator supply unit
121: separator heating unit
122: separator roll
130: negative electrode supply unit
131: negative electrode seating table
133: negative electrode roll
134: first cutter
135: first conveyor belt
136: negative electrode supply head
140: positive electrode supply unit
141: positive electrode seating table
143: positive electrode roll
144: second cutter
145: second conveyor belt
146: positive electrode supply head
150: negative electrode stack unit
151: first suction head
153: first moving unit
160: positive electrode stack unit
161: second suction head
163: second moving unit
170: holding mechanism
171: first holding mechanism
172: second holding mechanism
180: press unit
181: first pressing block
182: second pressing block
183, 184: press heater
S: stack
A: electromagnetic inductor
B: air blower

### DETAILED DESCRIPTION

Hereinafter, exemplary embodiments of the present invention will be described in detail such that one skilled in the art to which the present invention belongs can readily implement the same. However, the present invention may be embodied in various different forms and is not limited to the configurations described herein.

When one part “includes”, “comprises” or “has” one constituent element in the present specification, unless otherwise specifically described, this does not mean that another constitutional element is excluded but means that another constitutional element may be further included.

In the present specification, ‘p to q’ means a range of ‘p or more and q or less’.

When describing the present invention, detailed descriptions of related known technologies that may unnecessarily obscure the gist of the present invention will be omitted.

In the present specification, the ‘electrode’ means including the electrode and/or a semi-finished product of the electrode. In addition, the semi- finished product of the electrode refers to all semi-assembled products related to the electrode, such as a coated electrode, a rolled electrode, and a notched electrode manufactured in the process of manufacturing an electrode assembly and a secondary battery including the electrode assembly. That is, in the present specification, electrodes or semi-finished products of electrodes may be stacked in the electrode magazine unit.

In the present specification, ‘nth electrode’ is used to distinguish between electrodes with the same terminology and does not imply any specific order.

In the present specification, ‘electromagnetic inductor’ refers to a device that can induce an electric field or magnetic field in an electrode. Examples of the electromagnetic inductor include a magnet, and in this case, ‘magnet’ includes both a permanent magnet and an electromagnet. The electromagnet includes one whose magnetic flux density is changed by applied power. That is, the electromagnet can change the magnetic flux density depending on the applied power.

In the present specification, the ‘electrode magazine unit’ performs the function of stacking electrodes in a certain space therein like bullets in a magazine.

### <Electrode Supply Device>

An electrode supply device according to an exemplary embodiment of the present invention has a feature of separating a first electrode corresponding to an uppermost electrode among a plurality of electrodes stacked inside an electrode magazine unit by using an electromagnetic inductor capable of inducing an electric field or magnetic field. With this, only the uppermost electrode among the plurality of electrodes stacked in the electrode magazine unit can be separated, so that the problem of separation of multiple electrodes caused by contact between an electrode surface and an electrode surface or contact between the electrode surface and a separator can be prevented.

In an exemplary embodiment of the present invention, an electrode pickup unit can convey the first electrode to a stack table.

In an exemplary embodiment of the present invention, one of the plurality of electrodes may be a second electrode adjacent to the first electrode.

In an exemplary embodiment of the present invention, the electrode pickup unit may include a suction unit for suctioning the first electrode. The electrode pickup unit can fix the first electrode by applying a predetermined magnitude of suction force to the first electrode through the suction unit.

In an exemplary embodiment of the present invention, a repulsive force may be generated between one of the plurality of electrodes and the first electrode by the electromagnetic inductor. The repulsive force may be generated as a result of an electric field or magnetic field being induced in one of the plurality of electrodes by the electromagnetic inductor.

In an exemplary embodiment of the present invention, the suction force may be greater than the repulsive force. With this, only the first electrode in the electrode magazine unit can be separated, so that the problem of separation of multiple electrodes caused by contact between an electrode surface and an electrode surface or contact between the electrode surface and a separator can be prevented.

As a result, when an electrode assembly is manufactured using the electrode supply device according to an exemplary embodiment of the present invention, productivity can be improved.

The electrode supply device according to an exemplary embodiment of the present invention may include an electrode magazine unit in which electrodes are stacked. The electrode magazine unit performs a function of stacking electrodes.

The electrode supply device according to an embodiment of the present invention may include an electrode pickup unit including a suction unit for fixing an uppermost electrode among electrodes stacked inside the electrode magazine unit by applying a suction force of a certain magnitude to the uppermost electrode, and a conveying unit for picking up the uppermost electrode fixed by the suction unit and conveying the same to the stack table side. That is, the electrode pickup unit may include a suction unit and a conveying unit.

In an exemplary embodiment of the present invention, the electromagnetic inductor may be a magnetic body capable of inducing a magnetic field through a change in magnetic flux density. A repulsive force can be generated between the first electrode and one of the plurality of electrodes stacked inside the electrode magazine unit through the magnetic body. The electrode supply device according to an exemplary embodiment of the present invention may include at least one electromagnetic inductor. That is, the electromagnetic inductor may be provided in plural.

In an exemplary embodiment of the present invention, the electrode magazine unit may be located inside the electric field or magnetic field of the electromagnetic inductor. That is, the repulsive force can be generated between the first electrode and one of the plurality of electrodes only when the electrode magazine unit is located within the electric field or magnetic field of the electromagnetic inductor.

In an exemplary embodiment of the present invention, an electrode seating table may be further included on which the electrode conveyed by the electrode supply device unit is seated and positionally aligned. The electrode seated on the electrode seating table may be stacked on the stack table by an electrode stack unit, which will be described below.

The electrode supply device according to an exemplary embodiment of the present invention may further include a temperature sensor unit for measuring a surface temperature of the first electrode; and a control unit for controlling the induction of the electric field or magnetic field of the electromagnetic inductor so that the surface temperature satisfies a management temperature range. In an exemplary embodiment of the present invention, the management temperature range may be 30° C. to 140° C., preferably 30° C. to 120° C., and more preferably 30° C. to 100° C. When the induction of the electric or magnetic field by the electromagnetic inductor is controlled within a range in which the surface temperature of the negative electrode satisfies the management temperature range, the repulsive force can be generated without damaging the electrode itself, making electrode separation easier.

In an exemplary embodiment of the present invention, the magnetic body may induce a magnetic field by vibration.

In this case, in an exemplary embodiment of the present invention, the magnetic body may induce a magnetic field by vibration, and a vibration range of the magnetic body may be 1 mm to 25 mm, preferably 5 mm to 25 mm, and more preferably 8 mm to 25 mm. The vibration range refers to a magnitude of displacement generated by vibration, and when the range is satisfied, a repulsive force sufficient to separate the first electrode may be generated.

Additionally, in an exemplary embodiment of the present invention, the magnetic body may induce a magnetic field by vibration, and a frequency of the magnetic body may be 1 Hz to 1,000 Hz, and preferably 10 Hz to 1,000 Hz. When the frequency of vibration of the magnetic body satisfies the above range, a repulsive force sufficient to separate the first electrode may be generated.

The electrode supply device according to an exemplary embodiment of the present invention may further include an air blower. The air blower functions to supply air between the first electrode and the second electrode, making it possible to perform of the separation of the first electrode more easily.

In the present specification, the first electrode refers to the uppermost stacked electrode among a plurality of electrodes stacked in the electrode magazine unit.

In an exemplary embodiment of the present invention, the first electrode may be negative electrodes, respectively.

In an exemplary embodiment of the present invention, the first electrode may be positive electrodes, respectively.

In an exemplary embodiment of the present invention, the first electrode may be a negative electrode, and the second electrode may be a positive electrode.

In an exemplary embodiment of the present invention, the first electrode may be a positive electrode, and the second electrode may be a negative electrode.

### <Electrode Assembly Manufacturing Apparatus>

An exemplary embodiment of the present invention provides an electrode assembly manufacturing apparatus in which at least one of the negative electrode supply unit and the positive electrode supply unit includes the electrode supply device described above.

In an exemplary embodiment of the present invention, the negative electrode supply unit includes the electrode supply device.

In an exemplary embodiment of the present invention, the positive electrode supply unit includes the electrode supply device.

In an exemplary embodiment of the present invention, the negative electrode supply unit and the positive electrode supply unit each include the electrode supply device.

That is, both negative electrode supply unit and the positive electrode supply unit may supply the negative electrode and the positive electrode, respectively, using the electrode supply device according to the present invention.

In other words, the electrode assembly manufacturing apparatus according to an exemplary embodiment of the present invention may include an electrode supply unit for supplying an electrode to the stack table, and the electrode supply unit may include an electrode seating table on which an electrode is seated before the electrode is stacked on the stack table by the electrode stack unit. In addition, an electrode conveyed by the electrode supply device according to the present invention may be seated and positionally aligned on the electrode seating table. The electrode whose position is aligned may be stacked on the stack table by the electrode stack unit. In addition, the electrode may be a negative electrode or a positive electrode.

In the present specification, manufacturing a stack in which the negative electrode, the separator, and the positive electrode are stacked such that the negative electrode and the positive electrode are alternately arranged between the folds of the separator is referred to as zigzag folding. However, the electrode supply device of the present invention is not limited to electrode assemblies manufactured by the zigzag folding method and can also be applied to other types, that is, the lamination and stacking (L&S) process.

In the present specification, the stack may correspond to an unfinished electrode assembly. Additionally, in the present specification, a top end and a bottom end of the electrode assembly may be located at positions corresponding to an upper surface and a lower surface of the stack, respectively, or positions corresponding to a bottom surface and a top surface of the unfinished electrode assembly.

That is, in an exemplary embodiment of the present invention, the negative electrode supply unit may include the negative electrode supply device, and the positive electrode supply unit may include the positive electrode supply device. The negative electrode supply device and the positive electrode supply device may each be the electrode supply device according to the present invention.

In addition, in the electrode assembly manufacturing apparatus according to an exemplary embodiment of the present invention, the negative electrode supply unit may include a negative electrode seating table on which the negative electrode is seated before the negative electrode is stacked on the stack table by the negative electrode stacking unit, and the positive electrode supply unit may include a positive electrode seating table on which the positive electrode is seated before the positive electrode is stacked on the stack table by the positive electrode stacking unit.

The negative electrode stack unit 150 may include a first suction head 151 and a first moving unit 153. The first suction head 151 can vacuum-suction the negative electrode 11 seated on the negative electrode seating table 131.

In positive electrode stack unit 160 can stack the positive electrode on the positive electrode stack table 110. Here, the positive electrode stack unit 160 may have the same structure as the negative electrode stack unit 150 described above. In this case, the positive electrode stack unit 160 may include a second suction head 161 and a second moving unit 163.

In an exemplary embodiment of the present invention, in order to stack the negative electrode, the separator, and the positive electrode such that the negative electrode and the positive electrode are alternately arranged between the folds of the separator, a method in which the stack table is moved left and right, a method in which the separator is moved left and right or a method in which the stack table is rotated may be used, and general techniques in the relevant field may be applied to such methods.

The electrode assembly manufacturing apparatus according to an exemplary embodiment of the present invention may include a stack table moving unit for moving the stack table left and right, or a separator guide unit for moving the separator left and right. In addition, the stack table moving unit and the separator guide unit are not limited in forms as long as they respectively perform the functions of moving the stack table and the separator left and right, and devices generally used in the relevant field may be used.

The secondary battery manufacturing apparatus according to an exemplary embodiment of the present invention may further include a holding mechanism 170 for gripping and fixing the stack during a process of manufacturing the stack.

When the negative electrode 11 or the positive electrode 12 is stacked on the stack table 110, the holding mechanism 170 can fix the negative electrode 11 or positive electrode 12 to the stack table 110 while gripping the negative electrode 11 or the positive electrode 12. The holding mechanism 170 may include, for example, a first holding mechanism 171 and a second holding mechanism 172 and can fix both sides of the negative electrode 11 or positive electrode 12.

In an exemplary embodiment of the present invention, the press unit may further include a pair of the pressing blocks and a press heater for heating the pressing blocks, in which the pair of pressing blocks may move in directions facing each other to surface-press the stack and the press heater may heat the stack. In this case, in an exemplary embodiment of the present invention, the pair of the pressing blocks may include the press heater therein.

In an exemplary embodiment of the present invention, the stack may be heated using a heater included inside the stack table.

For pressure and temperature conditions of heating and pressing by the press unit, description of a condition of a heat-press step described below may be applied. The same also applies to the time (time condition) during which heating and pressure are applied.

Here, the pressure condition refers to a pressure applied by the pair of pressing blocks (or the pressing blocks for the stack table), and the temperature condition refers to a temperature of heat applied by the press heater or a heater included inside the stack table.

### <Electrode Supply Method>

In an exemplary embodiment of the present invention, there is provided an electrode supply method in which a first electrode corresponding to an uppermost electrode among a plurality of electrodes stacked in an electrode magazine unit is separated through the step of inducing an electric field or a magnetic field in one of the plurality of electrodes by an electromagnetic inductor.

The description of the electrode supply device according to the present invention can be applied to the electromagnetic inductor. That is, the electromagnetic inductor may be a magnetic body that can induce a magnetic field through a change in magnetic flux density, and the description of the electrode supply device according to the present invention can be applied to the vibration range and frequency of the magnetic body.

In an exemplary embodiment of the present invention, the step of fixing the first electrode among the plurality of electrodes stacked inside the electrode magazine unit by the electrode pickup unit may be a step of suctioning the first electrode with the suction unit. That is, the first electrode may be fixed by applying a suction force of a certain magnitude to a surface of the first electrode.

In an exemplary embodiment of the present invention, the step of inducing an electric field or magnetic field in one of a plurality of electrodes stacked inside the electrode magazine unit by the electromagnetic inductor may be a step of generating a repulsive force between any one of the plurality of electrodes and the first electrode. As described above, the suction force may be greater than the repulsive force.

With this, only the first electrode in the electrode magazine unit can be separated, so that the problem of separation of multiple electrodes caused by contact between an electrode surface and an electrode surface or contact between the electrode surface and a separator can be prevented. As a result, when the electrode assembly is manufactured by the electrode assembly manufacturing method according to an exemplary embodiment of the present invention, productivity can be improved.

As described above, in an exemplary embodiment of the present invention, one of the plurality of electrodes may be a second electrode adjacent to the first electrode. The above description may be applied to the first electrode and the second electrode. The electrode supply method according to an exemplary embodiment of the present invention may further include the step of conveying the first electrode to a stack table.

Additionally, in an exemplary embodiment of the present invention, the electrode supply method may further include the step of aligning a position of the conveyed electrode before supplying the electrode to the stack table. For the above step, the description of the electrode seating table described above may be applied.

The electrode supply method according to an exemplary embodiment of the present invention may further include the steps of measuring a surface temperature of the first electrode; and controlling the induction of the electric field or magnetic field by the electromagnetic inductor so that the surface temperature satisfies a management temperature range. In this case, as described above, the management temperature range may be 30° C. to 140° C. The above description can be applied to the management temperature range. The description of the electrode supply device according to the present invention described above can be applied to the electrode supply method according to the present invention, and vice versa.

### <Electrode Assembly Manufacturing Method>

An exemplary embodiment of the present invention provides an electrode assembly manufacturing method in which at least one of the step of supplying the negative electrode to the stack table side and the step of supplying the positive electrode to the stack table side includes the electrode supply method.

In an exemplary embodiment of the present invention, the step of supplying the negative electrode to the stack table side includes the electrode supply method according to the present invention.

In an exemplary embodiment of the present invention, the step of supplying the positive electrode to the stack table side includes the electrode supply method according to the present invention.

In an exemplary embodiment of the present invention, the step of supplying the negative electrode to the stack table side and the step of supplying the positive electrode to the stack table side each include the electrode supply method.

That is, both the step of supplying the negative electrode to the stack table side and the step of supplying the positive electrode to the stack table side may be configured to supply the negative electrode and the positive electrode, respectively, using the electrode supply method according to the present invention.

In an exemplary embodiment of the present invention, the step of manufacturing a stack by stacking the negative electrode, the separator, and the positive electrode on a stack table may include the steps of:
(S1) stacking the positive electrode on the stack table;
(S2) stacking the separator on the stack table such that the separator covers an upper surface of the positive electrode stacked on the stack table;
(S3) stacking the negative electrode on a surface of the separator covering the upper surface of the positive electrode opposite to the surface in contact with the positive electrode;
(S4) additionally supplying the separator to cover an upper surface of the negative electrode;
(S5) stacking the positive electrode on a surface of the separator covering the upper surface of the negative electrode opposite to the surface in contact with the negative electrode; and
(S6) additionally supplying the separator to cover an upper surface of the positive electrode, and
may be configured to repeat the steps (S1) to (S6) one or more times. That is, this case means a case where an electrode is first stacked on the stack table.

In an exemplary embodiment of the present invention, the step of manufacturing a stack by stacking the negative electrode, the separator, and the positive electrode on a stack table may include the steps of:
(SS1) stacking the separator on the stack table;
(SS2) stacking the negative electrode on an upper surface of the separator;
(SS3) additionally supplying the separator to cover an upper surface of the negative electrode;
(SS4) stacking the positive electrode on a surface of the separator covering the upper surface of the negative electrode opposite to the surface in contact with the negative electrode; and
(SS5) additionally supplying the separator to cover an upper surface of the positive electrode, and
may be configured to repeat the steps (SS1) to (SS5) one or more times. That is, this case means a case where a separator is first stacked on the stack table.

In an exemplary embodiment of the present invention, the step (S4), step (S6), step (SS3), and step (SS5), that is, the step of additionally supplying the separator to cover the upper surface of the negative electrode or positive electrode may be performed by one of a method in which the stack table is moved left and right, a method in which the separator is moved left and right, and a method in which the stack table is rotated. That is, the separator may be folded in a zigzag shape, and the stack may be manufactured by a zigzag folding process in which the negative electrode and the positive electrode are alternately arranged between the folds of the separator.

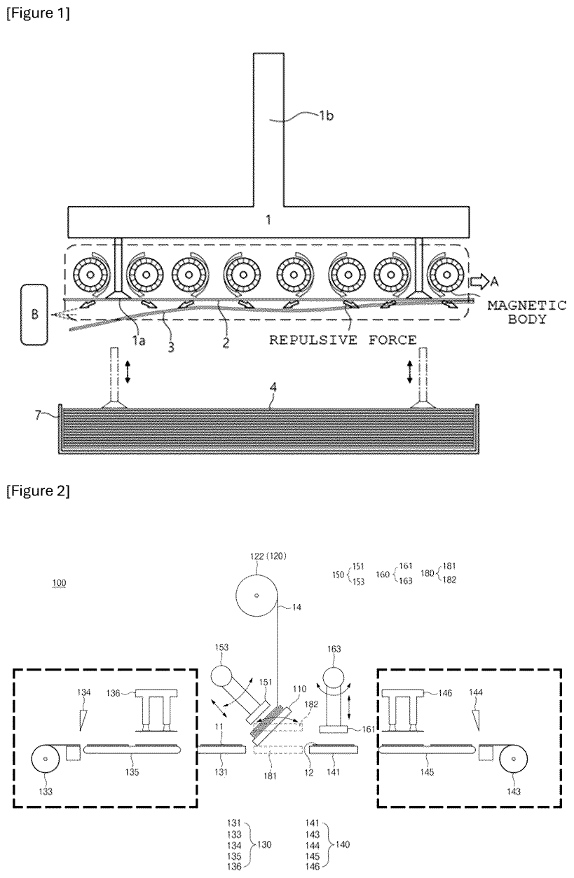

FIG. 1 is a view showing a process of separating an electrode in an electrode supply method and an electrode supply device according to an exemplary embodiment of the present invention. As shown in FIG. 1, in an electrode magazine unit 7, a first electrode 2, which is an uppermost electrode among electrodes stacked, a second electrode 3 in contact with the first electrode, and a plurality of other electrodes 4 are stacked. In this case, the first electrode 2 among the stacked electrodes is picked up and conveyed by an electrode pickup unit 1. In this case, the electrode pickup unit 1 may include a suction unit la and a conveying unit 1b. The suction unit la fixes the first electrode 2 with a suction force greater than a repulsive force generated by an electromagnetic inductor A. That is, by generating a repulsive force between the first electrode 2 and other electrodes stacked inside the electrode magazine unit 7 through changes in magnetic flux density of a plurality of magnetic bodies present inside the electromagnetic inductor A, a space between the first electrode 2 and the second electrode 3 can be widened. In this case, since the first electrode 2 is fixed by a suction force greater than the repulsive force generated by the electromagnetic inductor A, only the first electrode 2 can be separated. Additionally, separation can be made easier by injecting air with an air blower B. In addition, a surface temperature of the first electrode 2 is measured by a temperature sensor unit (not shown), and the change in magnetic flux density of the magnetic bodies present inside the electromagnetic inductor A can be controlled by a control unit (not shown) linked to the temperature sensor unit (not shown) so that a surface temperature measured by the temperature sensor unit (not shown) satisfies a management temperature range. The first electrode and the second electrode may be a negative electrode or a positive electrode, respectively.

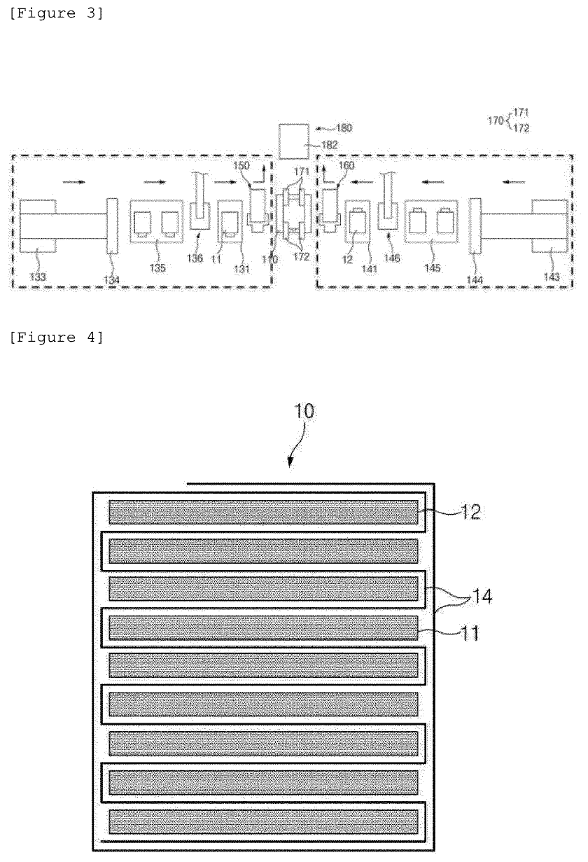

FIG. 2 is a plan view illustratively showing an electrode assembly manufacturing apparatus according to an exemplary embodiment of the present invention, and FIG. 3 is a front view showing a concept of the electrode assembly manufacturing apparatus according to the exemplary embodiment of the present invention. Here, for convenience, in FIG. 2, a holding mechanism 170 shown in FIG. 3 is omitted, and a press unit 180 positioned on a rear side in the plan view is indicated by the dotted line, and in FIG. 3, a separator supply unit 120 shown in FIG. 2 is omitted. For reference, the description related to FIG. 1 may be applied to the portion indicated by the dotted lines in FIGS. 2 and 3.

Referring to FIGS. 1 to 3, an electrode assembly manufacturing apparatus 100 according to an exemplary embodiment of the present invention includes a stack table 110, a separator supply unit 120 for supplying a separator 14, a negative electrode supply unit 130 for supplying a negative electrode 11, a positive electrode supply unit 140 for supplying a positive electrode 12, a negative electrode stack unit 150 for stacking the negative electrode 11 on the stack table 110, a positive electrode stack unit 160 for stacking the positive electrode 12 on the stack table 110, and a press unit 180 for adhering the negative electrode 11, the separator 14, and the positive electrode 12 therebetween. In addition, the electrode assembly manufacturing apparatus 100 according to an exemplary embodiment of the present invention may further include a holding mechanism 170 for fixing the negative electrode 11 and the positive electrode 12 when stacking the electrodes on the stack table 110. In this case, as shown in FIG. 1, the electrode pickup unit 1 can pick up and convey only the first electrode 2 among the stacked electrodes by using the repulsive force generated between the stacked electrodes by the electromagnetic conductor A inside the electrode magazine part 7 and the suction force greater than the repulsive force fixing the uppermost electrode 2. The first electrode and the second electrode may be a negative electrode and a positive electrode, respectively.

In addition, in an exemplary embodiment of the present invention, the negative electrode, the separator, and the positive electrode may be each supplied to the stack table while being heated.

That is, the separator supply unit may supply the separator to the stack table while heating the separator, and the negative electrode unit and the positive electrode supply unit may supply the negative electrode and the positive electrode to the stack table while heating the positive electrode and the negative electrode, respectively.

FIG. 4 is a cross-sectional view illustratively showing an electrode assembly. A secondary battery according to the present invention may include the electrode assembly.

Referring to FIGS. 2 to 4, the electrode assembly manufacturing apparatus 100 according to an exemplary embodiment of the present invention is an apparatus for manufacturing an electrode assembly 10 by stacking the negative electrode 11, the separator 14, and the positive electrode 12.

As shown in FIG. 3, the electrode assembly 10 is generally a chargeable/dischargeable power generating element and may be formed in such a form that the negative electrode 11, the separator 14, and the positive electrode 12 are alternately stacked and assembled. Here, the electrode assembly 10 may have such a form that the separator 14 is folded in a zigzag shape, for example, and the negative electrode 11 and the positive electrode 12 are alternately arranged between the folds of the separator 14. In this case, as shown in FIG. 3, the electrode assembly 10 may be provided in such a form that the separator 14 surrounds the outermost of the electrode assembly.

In an exemplary embodiment of the present application, the separator supply unit may further include a separator roll on which the separator is wound. The separator wound on the separator roll may be gradually unwound and supplied to the stack table. That is, the separator may be in the form of a separator sheet.

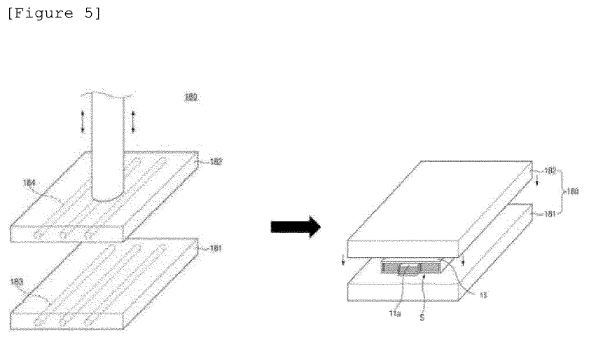

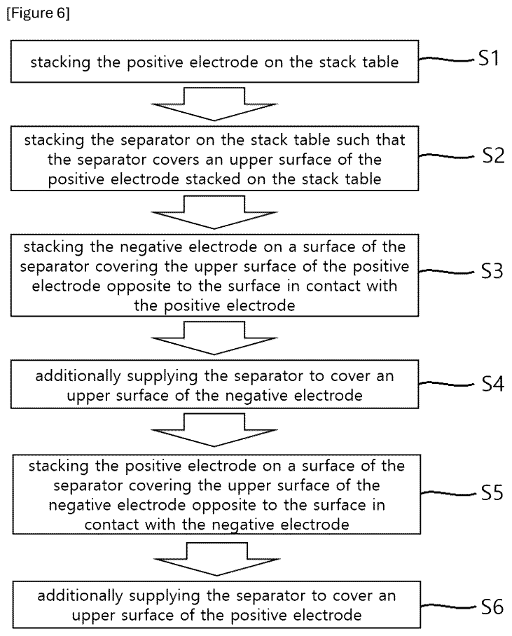

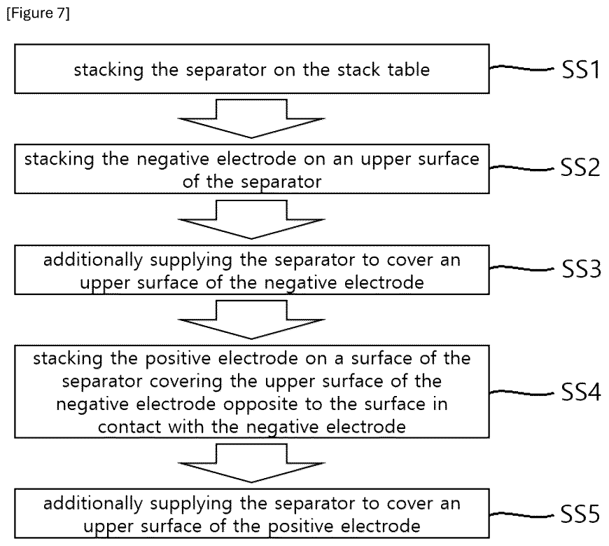

FIG. 5 is a perspective view illustratively showing a press unit of an electrode assembly manufacturing apparatus according to an exemplary embodiment of the present invention and a state in which the press unit presses a stack in the electrode assembly manufacturing apparatus according to the exemplary embodiment of the present invention.

Referring to FIGS. 2, 3, and 5, a press unit 180 includes a pair of pressing blocks 181 and 182, the pair of pressing blocks 181 and 182 are moved in directions facing each other, and a stack of the negative electrode 11, the separator 14, and the positive electrode 12 may be arranged between the pressing blocks 181 and 182. Then, the press unit 180 presses the stacked negative electrode 11, separator 14, and positive electrode 12 while heating and pressing the stack, thereby adhering the negative electrode 11, the separator 14, and the positive electrode 12 therebetween.

In addition, the press unit 180 may further include press heaters 183 and 184 for heating the pair of pressing blocks 181 and 182, so that the pair of pressing blocks 181 and 182 can heat and press the stack. Accordingly, thermal fusion between the negative electrode 11, the separator 14, and the positive electrode 12 in the stack may be better achieved, resulting in more robust adhesion.

The pair of pressing blocks 181 and 182 may have a pressing surface, and horizontal and vertical lengths of the pressing surface may be greater than horizontal and vertical lengths of the stack. The pair of pressing blocks 181 and 182 may include a first pressing block 181 and a second pressing block 182, and the first pressing block 181 and the second pressing blocks 182 may be provided as rectangular blocks having a rectangular parallelepiped shape.

Although the present invention has been described in detail with reference to the specific examples, this is intended to specifically describe the present invention, and the electrode assembly manufacturing apparatus according to the present invention is not limited thereto. It is apparent that various implementations are possible by one skilled in the art within the technical spirit of the present invention.

1. An electrode supply device comprising:
an electrode magazine unit in which a plurality of electrodes are stacked;
an electrode pickup unit configured to pick up a first electrode among the plurality of electrodes; and
an electromagnetic inductor configured to be able to induce an electric field or a magnetic field,
wherein one of the plurality of electrodes is separated from the first electrode by an electric field or magnetic field induced by the electromagnetic inductor.

2. The electrode supply device of claim 1, wherein the electrode pickup unit is configured to convey the first electrode to a stack table.

3. The electrode supply device of claim 1, wherein the one of the plurality of electrodes is a second electrode adjacent to the first electrode.

4. The electrode supply device of claim 1, further comprising:
a temperature sensor unit configured to measure a surface temperature of the first electrode; and
a control unit configured to control induction of an electric or magnetic field by the electromagnetic inductor so that the surface temperature satisfies a management temperature range.

5. The electrode supply device of claim 4, wherein the management temperature range is 30° C. to 140° C.

6. The electrode supply device of claim 1, wherein the electromagnetic inductor is a magnetic body configured to induce a magnetic field through a change in magnetic flux density.

7. The electrode supply device of claim 6, wherein the magnetic body is configured to induce a magnetic field by vibration, and a vibration range of the magnetic body is 1 mm to 25 mm.

8. The electrode supply device of claim 6, wherein the magnetic body is configured to induce a magnetic field by vibration, and a frequency of the magnetic body is 1 Hz to 1,000 Hz.

9. An electrode assembly manufacturing apparatus for manufacturing an electrode assembly comprising a negative electrode, a positive electrode, and a separator arranged between the negative electrode and the positive electrode, the electrode assembly manufacturing apparatus comprising:
a negative electrode supply unit configured to supply the negative electrode to a stack table side;
a positive electrode supply unit configured to supply the positive electrode to the stack table side;
a separator supply unit configured to supply the separator to the stack table side;
the stack table on which a stack in which the negative electrode, the separator, and the positive electrode are stacked such that the negative electrode and the positive electrode are alternately arranged between folds of the separator is manufactured; and
a press unit configured to heat and press the stack to adhere the negative electrode, the separator, and the positive electrode therebetween, thereby manufacturing an electrode assembly,
wherein at least one of the negative electrode supply unit and the positive electrode supply unit comprises the electrode supply device of claim 1.

10. An electrode supply method comprising:
fixing a first electrode among a plurality of electrodes stacked inside an electrode magazine unit by an electrode pickup unit;
inducing an electric field or magnetic field in one of the plurality of electrodes stacked inside the electrode magazine unit by an electromagnetic inductor; and
picking up the first electrode by the electrode pickup unit.

11. The electrode supply method of claim 10, further comprising conveying the first electrode to a stack table.

12. The electrode supply method of claim 10, wherein the one of the plurality of electrodes is a second electrode adjacent to the first electrode.

13. The electrode supply method of claim 10, further comprising:
measuring a surface temperature of the first electrode; and
controlling induction of an electric or magnetic field by the electromagnetic inductor so that the surface temperature satisfies a management temperature range.

14. The electrode supply method of claim 13, wherein the management temperature range is 30° C. to 140° C.

15. An electrode assembly manufacturing method for manufacturing an electrode assembly comprising a negative electrode, a positive electrode, and a separator arranged between the negative electrode and the positive electrode, the electrode assembly manufacturing method comprising:
supplying the negative electrode to a stack table side;
supplying the positive electrode to the stack table side;
supplying the separator to the stack table side;
manufacturing a stack by stacking the negative electrode, the separator, and the positive electrode on a stack table such that the negative electrode and the positive electrode are alternately arranged between the folds of the separator; and
heating and pressing the stack to adhere the negative electrode, the separator, and the positive electrode therebetween, thereby manufacturing an electrode assembly, wherein at least one of the supplying the negative electrode to the stack table side and the supplying the positive electrode to the stack table side comprises the electrode supply method of claim 10.
